(19) United States
(12) Patent Application Publication
(10) Pub. No.: US 2021/0349625 A1
(43) Pub. Date: Nov. 11, 2021

(54) USING A TOUCH INPUT TOOL TO MODIFY CONTENT RENDERED ON TOUCHSCREEN DISPLAYS

(71) Applicants: Wei LI, Markham (CA); Jun LI, Markham (CA); Qiang XU, Thornhill (CA); Chenhe LI, Markham (CA); Junwei SUN, Markham (CA); Gaganpreet SINGH, Markham (CA)

(72) Inventors: Wei LI, Markham (CA); Jun LI, Markham (CA); Qiang XU, Thornhill (CA); Chenhe LI, Markham (CA); Junwei SUN, Markham (CA); Gaganpreet SINGH, Markham (CA)

(21) Appl. No.: 16/867,247

(22) Filed: May 5, 2020

(51) Int. Cl. G06F 3/0488; G06T 11/40; G06F 3/0485

(52) U.S. Cl. CPC G06F 3/04883; G06F 3/03545; G06F 3/0485; G06T 11/40

(57) ABSTRACT

A method is provided including generating touch coordinate information corresponding to touch interactions with a touchscreen display of an electronic device and updating information rendered on the touchscreen display in response to determining that the touch coordinate information matches a tool shaft movement gesture corresponding to movement of a touch tool shaft over an area of the touchscreen display. A device is provided, including a touchscreen display comprising a display and a touch sensing system configured to generate signals corresponding to screen touches of the display, a processing device operatively coupled to the touchscreen display, and a non-transitory memory coupled to the processing device and storing software instructions that when executed by the processing device configure the processing device to carry out the provided method. The ability to process tool shaft gestures may improve one or both of the operation of the device and the user experience with the device.

### FIELD

This disclosure relates generally to touchscreen displays and the use of a touch input tool with touchscreen displays.

### BACKGROUND

Electronic devices often have touchscreen displays to enable user interaction with the device. Users can input information through simple or multi-touch gestures by touching the touchscreen display with an input device such as a pen-style stylus or with one or more fingers.

Pen-type styluses have been widely used as touch input tools on electronic devices with touchscreen displays. A stylus typically has a shaft and a tip. Most of the research related to styluses has been either focused on the accuracy of handwriting, or methods of interactions with touchscreen displays via the stylus tip.

A common way for a user to interact with a touchscreen display is to through touch gestures using fingers or the end of a pen-style stylus. By way of example, gestures and their corresponding descriptions that can be recognized by the Microsoft Surface™ operating system based on finger-based touch events include: “Tap: Press and then release”; “Slide or Push: Move a displayed object under finger with a sliding or pushing action: “Flick: Press, slide quickly, and then release”; “Touch-and-turn: Slide finger on the content around a point of the content”; “Spin: Twist quickly to rotate the object”; “Pull apart Stretch: Pull fingers apart on two hands”; “Push together Shrink: Bring fingers together on two hands”; “Twist: Twist the object with two or more fingers, like turning a knob or paper”; “Pinch: Bring two fingers together on one hand”; “Squeeze: Bring three or more fingers together on one hand”; “Spread: Pull fingers apart on one hand” and “Pin turn: Pin the object in place with one finger while the other finger drags the object around the pinned point”

As evidenced from the above list, other than basic tap and drag gestures that can be performed using a stylus tip, most touchscreen interactions often require finger based gestures, with the result that users who want to use a stylus often have to switch to finger gestures to take advantage of advanced touchscreen capability. Some graphical applications allow a user to select multiple objects on the screen and perform one or more actions thereon. Selecting multiple objects using a stylus tip requires tapping each object with the tip, and actuating at least one more command to perform an action on the selected objects. Additionally, switching to finger gestures and selecting multiple objects with a human finger is error prone if at least some of the objects are small. Furthermore, selecting multiple objects can also be time consuming if the number of screen objects is large thus requiring multiple stylus tip or finger taps. However, small screen objects may not be easily selected with finger taps due to the size of human fingertips in comparison with the screen objects. Some applications permit performing actions on an area of its user interface. Performing such actions with a stylus tip requires multiple steps. For example, at least two corners of the area need to be selected by the stylus tip, then further interactions or gestures by the stylus tip would be required to initiate an action modifying the contents of the selected area. In this case, the user may prefer to switch to using finger gestures and select the area using multi-touch finger gestures. However, human fingers may not be adequate in selecting an area of the screen with sufficient accuracy in some applications. Some data management applications permit performing actions on numerical data in an area of the user interface thereof, such as a table. This requires selecting an area of the display containing the numerical data, such as selecting a table region in a spreadsheet application. A number of taps by a stylus tip or a human finger would be required to select the area, and further taps on a menu item initiating a comment would be needed.

Accordingly, there is a need for a more versatile way of modifying the content rendered on touchscreen displays. It is desirable to develop easy-to-use input interactions, including for example interactions that enable the manipulation of multiple objects displayed in a viewing area of a touchscreen display.

### SUMMARY

In accordance with an aspect of the present disclosure, there is provided a method that includes generating touch coordinate information corresponding to touch interactions with a touchscreen display of an electronic device, and updating information rendered on the touchscreen display in response to determining that the touch coordinate information matches a tool shaft movement gesture corresponding to movement of a touch tool shaft over an area of the touchscreen display.

In accordance with the previous aspect, the method further includes defining a touch tool interaction area based on the touch coordinate information, wherein updating information rendered on the touchscreen display is selectively performed on information included within the touch tool interaction are.

In accordance with any of the preceding aspects, defining the touch tool interaction area comprises determining, based on the touch coordinate information, a starting location of the touch tool shaft movement gesture and an ending location of the touch tool shaft movement gesture on the touchscreen display.

In accordance with any of the preceding aspects, the tool shaft movement gesture corresponds to one or more of: a tool shaft drag gesture, a tool shaft rotation gesture, and a combined tool shaft drag and rotation gesture.

In accordance with any of the preceding aspects, the starting location of the tool shaft movement gesture corresponds to a location of a tool shaft placement gesture on the touchscreen display and the ending location of the tool shaft movement gesture corresponds to a tool shaft removal gesture from the touchscreen display.

In accordance with any of the preceding aspects, updating information rendered on the touchscreen display comprises resizing the information rendered on the touchscreen display or scrolling information rendered on the touchscreen display based on a direction of the tool shaft movement gesture.

In accordance with any of the preceding aspects, the selected attribute is a fill color.

In accordance with any of the preceding aspects, a plurality of image elements of different types are rendered in the touch tool interaction area, and updating information rendered on the touchscreen display comprises selectively moving or copying a plurality of the image elements of a selected type from the touch tool interaction area to a different area of the touchscreen display.

In accordance with any of the preceding aspects, a plurality of numerical data elements are rendered in the touch tool interaction area, and updating information rendered on the touchscreen display comprises updating values of the data elements included within the touch tool interaction area based on a predetermined function.

In accordance with any of the preceding aspects, the method further includes storing the updated information in a non-transitory storage.

In accordance with another aspect of the present disclosure, there is provided an electronic device that includes a touchscreen display comprising a display and a touch sensing system configured to generate signals corresponding to screen touches of the display, a processing device operatively coupled to the touchscreen display, and a non-transitory memory coupled to the processing device. The non-transitory memory stores software instructions that when executed by the processing device configure the processing device to generate touch coordinate information corresponding to touch interactions with a touchscreen display of an electronic device, and update information rendered on the touchscreen display in response to determining that the touch coordinate information matches a tool shaft movement gesture corresponding to movement of a touch tool shaft over an area of the touchscreen display.

In accordance with the preceding aspect, the software instructions further configure the processing device to define a touch tool interaction area based on the touch coordinate information, wherein updating information rendered on the touchscreen display is selectively performed on information included within the touch tool interaction area.

In accordance with any of the preceding aspects, the instructions which configure the processing device to define the touch tool interaction area comprise instructions which configure the processing device to determine, based on the touch coordinate information, a starting location of the touch tool shaft movement gesture and an ending location of the touch tool shaft movement gesture on the touchscreen display.

In accordance with any of the preceding aspects, the tool shaft movement gesture corresponds to one or more of: a tool shaft drag gesture, a tool shaft rotation gesture, and a combined tool shaft drag and rotation gesture.

In accordance with any of the preceding aspects, the starting location of the tool shaft movement gesture corresponds to a location of a tool shaft placement gesture on the touchscreen display and the ending location of the tool shaft movement gesture corresponds to a tool shaft removal gesture from the touchscreen display.

In accordance with any of the preceding aspects, the instructions which configure the processing device to update information rendered on the touchscreen display comprise instructions which configure the processing device to one of: resize the information rendered on the touchscreen display, scroll information rendered on the touchscreen display based on a direction of the tool shaft movement gesture, and change a selected attribute of image elements rendered within the touch tool interaction area.

In some examples of the preceding aspects, a plurality of image elements of different types are rendered in the touch tool interaction area, and updating information rendered on the touchscreen display comprises selectively moving or copying a plurality of the image elements of a selected type from the touch tool interaction area to a different area of the touchscreen display or updating values of the data elements included within the touch tool interaction area based on a predetermined function.

In at least some of the forgoing aspects, the ability to process tool shaft gestures may improve one or both of the operation of an electronic device and the user experience with the electronic device. For example, facilitating more efficient user interactions with an electronic device through the use of tool shaft gestures may enable display content modification to be achieved with fewer, and more accurate interactions. Fewer interactions with the electronic device reduce possible wear or damage to the electronic device and possibly reduce battery power consumption. Furthermore, a user may be able to replace some finger interactions with a touchscreen display with stylus interactions, thereby reducing potential transfer of foreign substances such as dirt, grease, oil and other contaminants (including for example bacteria and viruses) from the user's fingers to the touchscreen display. Reduced contaminants on the screen may in some cases reduce cleaning requirements for the touchscreen display thereby reducing possible damage to the device, reducing the consumption of cleaning materials, and may also reduce the spread of contaminates.

### BRIEF DESCRIPTION OF THE DRAWINGS

Reference will now be made, by way of example, to the accompanying drawings which show example embodiments of the present application, and in which:

FIG. 1A shows an electronic device employing a touchscreen display, wherein the shaft of a touch input tool in the form of a stylus is placed on the screen of the touchscreen display in a generally vertical orientation;

FIG. 1B shows the electronic device of FIG. 1A wherein the shaft of the touch input tool is placed on the screen of the touchscreen display in a generally horizontal orientation;

FIG. 2 is a block diagram of selected components of a touchscreen system of the electronic device of FIGS. 1A and 1B, according to example embodiments;

FIG. 3A depicts tool shaft placement and removal gestures by the shaft of a touch input tool in the form of a rigid rod in relation to the screen of a touchscreen display;

FIG. 3B depicts a tool shaft drag gesture by the shaft of the touch input tool in the form of a rigid rod in relation to the screen of a touchscreen display;

FIG. 3C depicts a tool shaft rotate gesture by the shaft of a touch input tool in the form of a rigid rod in relation to the screen of a touchscreen display;

FIG. 4A, depicts an area interaction utilizing a tool shaft drag and removal gesture for selecting and enlarging an area of the user interface of a mapping application running on an electronic device, in accordance with embodiments of the present disclosure;

FIG. 4B depicts the mapping application of FIG. 4A showing the selected area which has been enlarged in response to the area interaction;

FIG. 5 illustrates a mapping of a set of actions to respective spatial and temporal combinations of tool shaft gestures.

FIG. 6A depicts an area interaction utilizing a tool shaft drag and removal gesture for color filtering an area of a drawing shown in a graphics application, in accordance with embodiments of the present disclosure;

FIG. 6B depicts the graphics application of FIG. 6A showing the selected area which has been color filtered in response to the area interaction;

FIG. 7A depicts an area interaction utilizing a tool shaft drag gesture for selecting and moving a plurality of shapes displayed in a graphics application, in accordance with embodiments of the present disclosure;

FIG. 7B depicts the user interface of the graphics application of FIG. 7A showing a plurality of shapes which have been selected to be moved to a new location in response to the area interaction;

FIG. 7C depicts the user interface of the graphics application of FIG. 7A showing the selected plurality of shapes after a tool shaft removal gesture;

FIG. 7D depicts the user interface of the graphics application of FIG. 7A showing the selected plurality of shapes which have been moved to a new location in response to the area interaction;

FIG. 8A depicts an area interaction utilizing a tool shaft drag and removal gesture for manipulating numerical data in a table of a spreadsheet application, in accordance with embodiments of the present disclosure;

FIG. 8B depicts the user interface of the spreadsheet application of FIG. 8A showing a modified content of some of the data values in the table in response to the area interaction;

FIG. 9A depicts an area interaction utilizing a tool shaft rotate gesture for rotating a map in a mapping application displayed on a touchscreen display of an electronic device, in accordance with embodiments of the present disclosure;

FIG. 9B depicts the user interface of the mapping application of FIG. 9A showing a rotated view of the map in response to the area interaction;

FIG. 10 shows a flow diagram of a method of updating content according to example embodiments.

FIG. 11 depicts a block diagram representing an example electronic device capable of carrying out the methods described here, in accordance with embodiments of the present disclosure.

### DESCRIPTION OF EXAMPLE EMBODIMENTS

In this disclosure the term “electronic device” refers to an electronic device having computing capabilities. Examples of electronic devices include but are not limited to: personal computers, laptop computers, tablet computers (“tablets”), smartphones, surface computers, augmented reality gear, automated teller machines (ATM)s, point of sale (POS) terminals, and the like.

In this disclosure, the term “display” refer to a hardware component of an electronic device that has a function of displaying graphical images, text, and video content thereon. Non-limiting examples of displays include liquid crystal displays (LCDs), light-emitting diode (LED) displays, and plasma displays.

In this disclosure, a “screen” refers to the outer user-facing layer of a touchscreen display.

In this disclosure, the term “touchscreen display” refers to a combination of a display together with a touch sensing system that is capable of acting as an input device by receiving touch input. Non-limiting examples of touchscreen displays are: capacitive touchscreens, resistive touchscreens, Infrared touchscreens and surface acoustic wave touchscreens.

In this disclosure, the term “touchscreen-enabled device” refers to an electronic device equipped with a touchscreen display.

In this disclosure, the term “viewing area” or “view” refers to a region of a display, which may for example be rectangular in shape, which is used to display information and receive touch input.

In this disclosure, the term “main viewing area” or “main view” refers to the single viewing area that covers all or substantially all (e.g., greater than 95%) of the viewable area of an entire display area of a touchscreen display.

In this disclosure, the term “touch event” refers to an event during which a physical object is detected as interacting with the screen of a touchscreen display.

In this disclosure, the term “interaction” refers to one or more touch tool gestures applied to a touchscreen display.

In this disclosure, the term “area interaction” refers to one or more tool shaft gestures applied to an area of a viewing area on a touchscreen display.

In this disclosure, the term “separator” refers to a linear display feature, for example a line that visually separates two adjacent viewing areas that are displayed simultaneously on touchscreen display. Examples of separators include a vertical separator such as one or more vertical lines that provide a border separating a right and a left viewing areas, and a horizontal separator such as one or more horizontal lines that provide a border separating a top viewing area and a bottom viewing area. The separator may or may not explicitly display a line demarking the border between first and second viewing areas.

In this disclosure, the term “display layout” refers to the configuration of viewing areas on a display. For example, the main viewing area may have a display layout in which it is in a vertical split mode or a horizontal split mode, or a combination thereof.

In this disclosure, a “window” refers to a user interface form showing at least part of an application's user interface.

In this disclosure, the term “application” refers to a software program comprising of a set of instructions that can be executed by a processing device of an electronic device.

In this disclosure, the term “executing” and “running” refer to executing, by a processing device, at least some of the plurality of instructions comprising an application.

In this disclosure, the term “home screen” refers to a default user interface displayed by a graphical operating system on the touchscreen display of an electronic device when no foreground application is running. A home screen typically displays icons for the various applications available to run on the electronic device. However, a home screen may also include other user interface elements such as tickers, widgets, and the like.

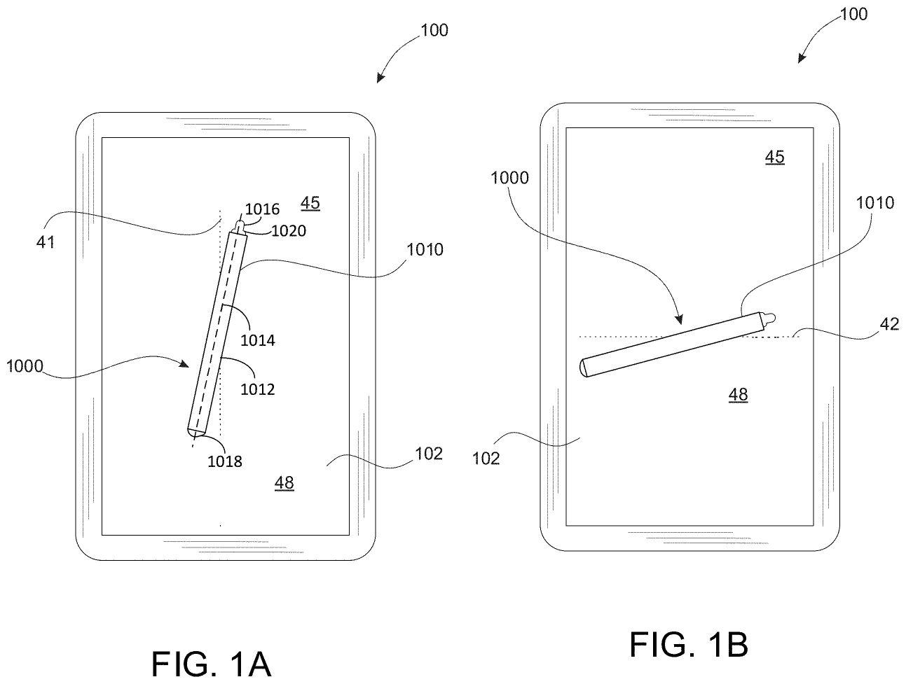

In example embodiments, an electronic device and a touch input tool, such as a stylus are cooperatively configured to enable the content displayed on a touchscreen display of the electronic device to be modified based on interaction of the shaft of the stylus with the touchscreen display. In this regard, FIGS. 1A and 1B, show an electronic device 100, which in the illustrated examples is a tablet device, having a touchscreen display 45, together with a touch input tool 1000, in the form of a pen-style stylus, according to example embodiments. In example embodiments, the touch input tool 1000 is an inanimate object styled like a pen, having a rigid body 1012 that extends along an elongate axis 1014 from a first axial end 1016 to a second axial end 1018. The rigid body 1012 includes a tool shaft 1010 that extends along elongate axis 1014 and is located between the first end 1016 and second end 1018 of the body 1012. In example embodiments, the tool shaft 1010 can allow a user to grip the touch input tool 1000 and is cylindrical or cuboid shaped along its length. Touch input tool 1000 may have a tapered tip 1020 provided at one or more of the axial ends 1016, 1018 of the body 1012. The tip 1020 may be used to actuate user-interface elements on a touchscreen display. In some examples, stylus 1000 may also incorporate a writing pen. For example, touch input tool 1000 may have an ink-dispensing writing tip at an opposite end than the tip 1020.

In example embodiments, electronic device 100 is configured to enable non-tip portions of the touch input tool 1000, namely tool shaft 1010, to be used to provide touch input to touchscreen display 45. In this regard, in FIGS. 1A and 1B, touch input tool 1000 is placed on a portion of the touchscreen display 45 such that the elongate axis 1014 of tool shaft 1010 is parallel to a viewing surface of the screen 48 of touchscreen display 45. In some embodiments, the tool shaft 1010 has a plurality of contact points which are spaced apart along the shaft 1010 for contacting the screen 48. In other embodiments, a continuous portion of the length of the shaft 1010 is configured to contact with the screen.

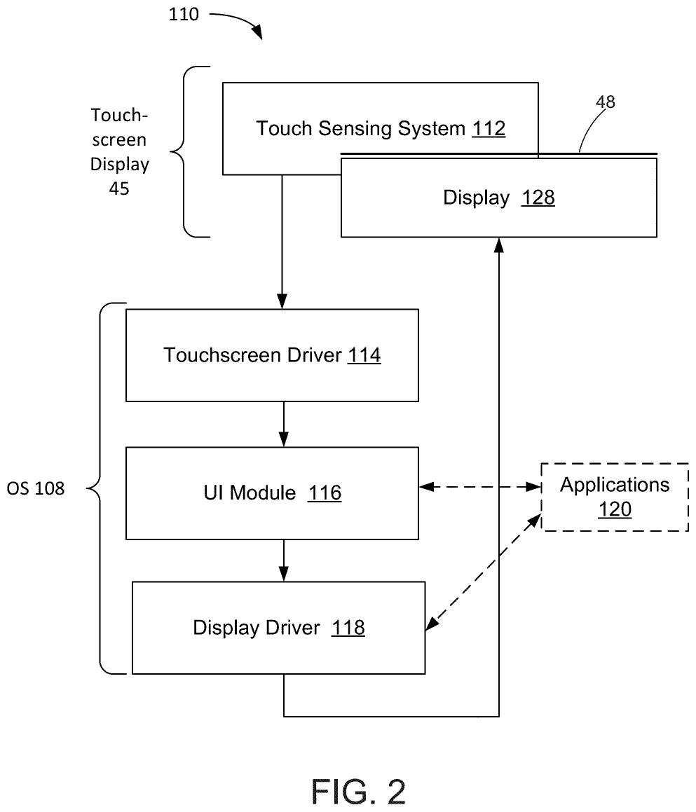

FIG. 2 shows selected hardware and software components of a touchscreen display system 110 of the electronic device 100 for detecting and processing information about interaction of the touch input tool 1000 with the touchscreen display 45. The hardware components of the touchscreen display system 110 include the touchscreen display 45, which includes a display 128, and a touch sensing system 112 for detecting touch events with the screen 48 of the display 128.

Different technologies known in the art can be used to implement touch sensing system 112 in different example embodiments.

In one example embodiment, touchscreen display 45 is a capacitive touchscreen display such as a surface capacitive touchscreen and the touch sensing system 112 is implemented by a screen that stores an electrical charge, together with a monitoring circuit that monitors the electrical charge throughout the screen. When the capacitive screen of display 128 is touched by a conductive object that is capable of drawing a small amount of the electrical charge from the screen, the monitoring circuit generates signals indicating the point(s) of contact for the touch event. In example embodiments that use a capacitive touchscreen display, the shaft 1010 of the touch input tool 1000 is specially configured to enable the presence of the shaft 1010 on the screen of display 128 to be detected by the touch sensing system 112. In this regard, in some example embodiments the shaft 1010 includes one or more screen contact points that can transfer an electrical charge. For example, the shaft 1010 may include conductive contact points which are spaced apart along the shaft 1010 for contacting the screen. The conductive contact points may be electrically connected to one or more human user contact surfaces on the touch input tool 1000 that allow a conductive path from a human user to the conductive contact points. In some embodiments, a continuous portion of the length of the shaft 1010 may have a conductive element configured to contact with the screen. In some examples, the touchscreen display 45 may be a projected capacitance touchscreen display rather than a surface touchscreen display, in which case a touch event such as a tool shaft placement gesture may occur when the touch input tool 1000 is sufficiently close to the screen to be detected without actual physical contact.

In a further example embodiment, touchscreen display 45 is a resistive touch screen and the touch sensing system 112 includes a screen that comprises a metallic electrically conductive coating and resistive layer, and a monitoring circuit generates signals indicating the point(s) of contact based on changes in resistance.

In a further example embodiment, touchscreen display 45 is a SAW (surface acoustic wave) or surface wave touchscreen and touch sensing system 112 sends ultrasonic waves and detects when the screen is touched by registering changes in the waves. In such embodiments the acoustic wave absorbing material is provided on the shaft 1010 of touch input tool 1000

In yet further example embodiment, touchscreen display 45 is an Infrared touch screen and the touch sensing system 112 utilizes a matrix of infrared beams that are transmitted by LEDs with a phototransistor receiving end. When an object is near the display, the infrared beam is blocked, indicating where the object is positioned.

In each of the above examples, the touch sensing system 112 generates digital signals that specify the point(s) of contact of an object with the screen of the display 128 for a touch event. These digital signals are processed by software components of the touchscreen display system 110, which in an example embodiment may be part of operating system (OS) software 108 of the electronic device 100. For example, the OS software 108 can include a touchscreen driver 114 that is configured to convert the signals from touch sensing system 112 into spatial touch coordinate information that specifies a physical location of object contact point(s) on the screen of display 128 (for example a set of multiple X and Y coordinates that define a position of the tool shaft 1010 relative to a defined coordinate system of the touchscreen display 45). In example embodiments the spatial coordinate information generated by touchscreen driver 114 is provided to a user interface (UI) module 116 of the OS software 108 that associates temporal information (e.g., start time and duration) with the spatial coordinate information for a touch event, resulting a touch coordinate information that includes spatial coordinate information and time information. In further example embodiments, the touchscreen driver 114 is capable of detecting the pressure exerted by object contact point(s) on the screen of display 128. In this case pressure information is also provided to the user interface module 116. The UI module 116 is configured to determine if the touch coordinate information matches a touch pattern from a set of candidate touch patterns, each of which corresponds to a respective touch input action, commonly referred to as a gesture.

In example embodiments, in addition to detecting and recognizing conventional finger and stylus tip gestures such as the Microsoft Surface™ gestures noted above, the UI module 116 is configured to identify, based on touch coordinate information, a set of basic tool shaft gestures that match touch patterns that correspond to: (1) placement of the shaft 1010 of touch input tool 1000 on the screen of display 128 (“tool shaft placement gesture”); (2) movement of the shaft 1010 of touch input tool 1000 on the screen of display 128 of touchscreen display 45 (an on-screen “tool shaft movement gesture” can be further classified as a “tool shaft drag gesture” in the case of a linear movement, a “tool shaft rotation gesture” in the case of a rotational movement, and a “tool shaft drag-rotation gesture” in the case of a combined tool shaft drag and rotation gestures) and (3) removal of the shaft 1010 of touch input tool 1000 from the screen of display 128 (“tool shaft removal gesture”). In example embodiments, described in greater detail below, the UI module 116 is configured to further classify the above gestures based on the location, orientation and timing of such tool shaft gestures. Thus, the touch coordinate information derived by the touchscreen driver 114 from the signals generated by touch sensing system 112 includes information about the location, orientation and shape of an object that caused a touch event, and timing information about the touch events. That information can be used by UI module 116 to classify the touch event as a tool shaft gesture or a combination of tool shaft gestures, where each tool shaft gesture which has a respective predefined touch pattern.

In example embodiments, based on at least one of the type and location of a detected tool shaft gesture, the UI module 116 is configured to alter the rendered content on the display 128 by providing instructions to a display driver 118 of the OS 108. In example embodiments, components of the OS 108 such as the UI module 116 interact with UI components of other software programs (e.g., other applications 120) to coordinate the content that is displayed in viewing areas on the display 128. In some examples, other applications 120 may include a browser application or an application programing interface (API) that interfaces through a network with a remotely hosted service.

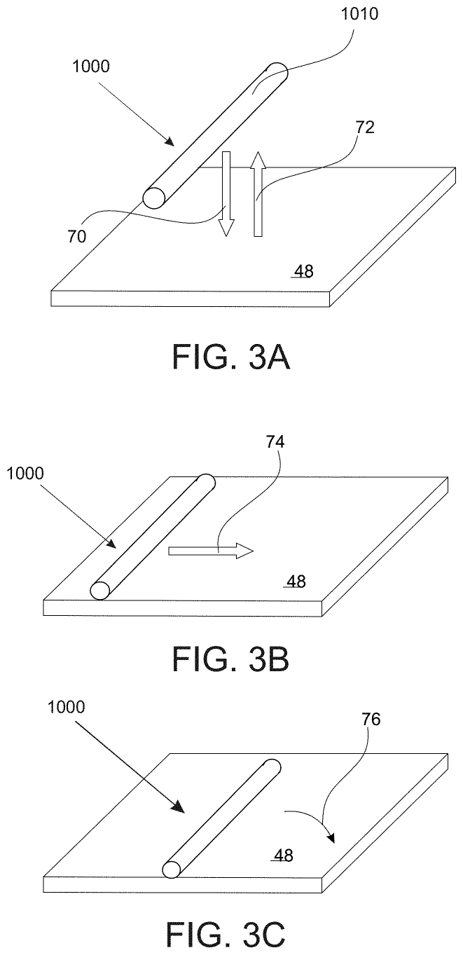

Types of tool shaft gestures such as those mentioned above are briefly illustrated with reference to FIGS. 3A-3C. FIG. 3A depicts a touch input tool 1000 having an elongate shaft 1010 positioned above the screen 48 of a touchscreen display 45. The touch input tool 1000 may be moved (lowered) in the direction of the arrow 70 until its shaft 1010 is placed on the screen 48 as described above with respect to the touch input tool 1000 of FIGS. 1A and 1B. This is referred to as the “tool shaft placement” gesture. By way of example, UI module 116 may be configured to determine that a “tool shaft placement” gesture has occurred when the spatial touch coordinate information matches a touch pattern that corresponds to an elongate, stylus shaped object, having a linear axis and being at least a threshold length (e.g., at least 7 cm (2.76 inches), although other threshold distances are possible) is placed on screen 48 for at least a minimum threshold duration of time (e.g., 500 ms, although other time durations can be used). Similarly, UI module 116 is configured to classify subsequent removal of touch input tool 1000 off the screen 48 in the direction of the arrow 72 as a “tool shaft removal gesture”. FIG. 3B depicts the touch input tool 1000 being dragged along the screen 48 in the direction of the arrow 74. The touch input tool 1000 is first placed on the screen 48, as described above, then dragged across the screen 48 while maintaining contact therewith and while being touched by a human user. The touch input tool 1000 maintains its orientation with respect to the screen. The touch input tool 1000 ends up in a new location on the screen 48 at which it is parallel to but spaced from its original location on the screen 48. This is referred to as the “tool shaft drag gesture”. FIG. 3C depicts the touch input tool 1000 being rotated with respect to the screen 48 in the direction of the arrow 76. The rotation of the touch input tool 1000 may be in the clockwise direction or the counter-clockwise direction. This is known as the “tool shaft rotation gesture”.

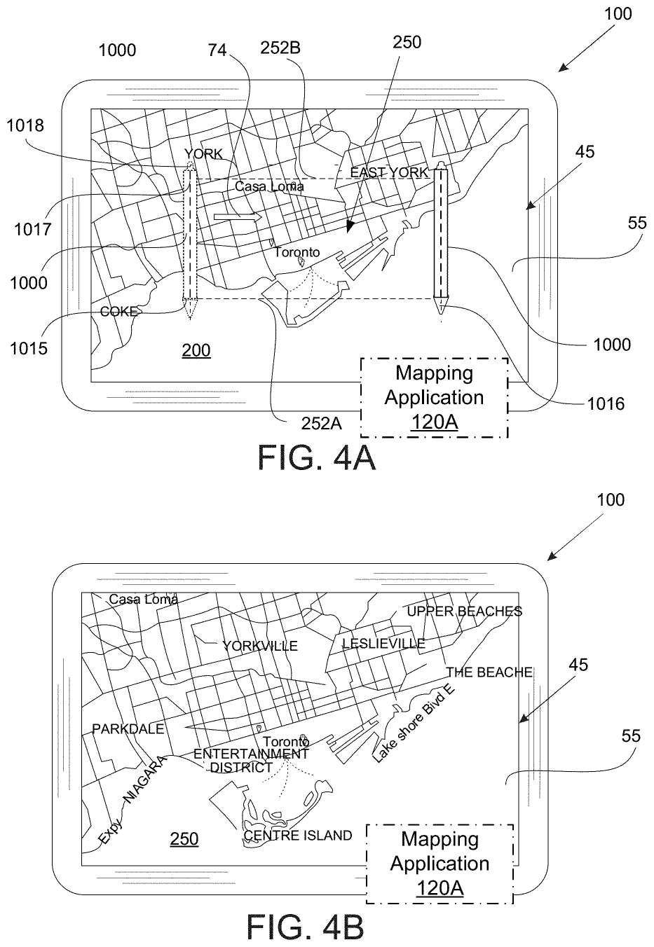

Referring again to FIGS. 1A and 1B, in some examples, the various tool shaft gestures can be further classified by orientation. FIGS. 1A and 1B correspond respectively to a “vertical tool shaft placement gesture” and a “horizontal tool shaft placement gesture”. In the illustrated example, of FIGS. 1A and 1B, the electronic device 100 is shown in what is commonly referred to as a “portrait orientation mode” in which the shorter dimension of the rectangular touchscreen display 45 defines the width (e.g. distance from left edge to right edge) of a main viewing area and the longer dimension of the rectangular touchscreen display 45 defines the height (e.g., distance from top edge to bottom edge) of the main viewing area. In example embodiments, the electronic device 100 can also operate in a “landscape orientation mode” in which the shorter dimension of the rectangular touchscreen display 45 defines the vertical height of a main viewing area and the longer dimension of the rectangular touchscreen display 45 defines the horizontal width of the main viewing area. The dotted vertical line 41 of FIG. 1A is a vertical virtual line splitting the main viewing area of the touchscreen display 45 into a right viewing area and a left viewing area, and represents a touch pattern corresponding to a vertical tool shaft placement gesture. In FIG. 1A, the touch input tool 1000 is placed on the screen 48 of touchscreen display 45 such that the tool shaft 1010 is substantially parallel to and generally coincides with the touch pattern represented by vertical virtual line 41. The touch sensing system 112 generates signals that correspond to a sensed location of the shaft 1010 on the touchscreen display 45. Touchscreen driver 114 translates these signals into spatial touch coordinate information. In the illustrated example, UI module 116 compares the touch coordinate information against a number of predetermined touch patterns and determines that the touch coordinate information corresponds to a touch pattern (represented by virtual line 41), for a vertical tool shaft placement gesture located at a vertical center of the touchscreen display 45. In example embodiments, the UI module 116 allows for some deviation between the orientation of the touch input tool 1000 and the touch pattern represented by virtual vertical line 41. For example, the touchscreen UI module 116 may consider an angle of up to +/−20 degrees between an elongate axis 1014 of the shaft of the stylus 1000 and the vertical virtual line 41 to be a negligible angle. As such a touch input tool 1000 placed such that its shaft 1010 is parallel to the virtual vertical line 41 or deviating up to a threshold orientation deviation amount (e.g., 20 degrees) from that orientation is considered to match the touch pattern represented by virtual vertical line 41, which corresponds to a vertical tool shaft placement gesture. Similarly, the dotted horizontal line 42 of FIG. 4B is a virtual horizontal line representing the touch pattern for a horizontal tool shaft placement gesture on the main viewing area of the touchscreen display 55. The placement of the touch input tool 1000 on the virtual line 42 or with an angle of deviation between the elongate axis 1014 of shaft 1010 of the touch input tool 1000 and the touch pattern represented by horizontal virtual line 42 of up to the defined orientation deviation threshold (e.g., 20 degrees) is considered to be a placement of the touch input tool 1000 in a substantially or generally horizontal orientation in a center location on the main viewing area of the touchscreen display 45.

In addition to or instead of having a defined angle value tolerance for orientation deviation, the UI module 116 may also be configured to apply a distance deviation threshold in cases where the proximity of the tool shaft gesture is determined relative to a displayed landmark (e.g. a separator as described below). For example, UI module 116 may consider a touch input tool shaft 1010 to be placed at or coincident with a displayed landmark if the closest part of the touch input tool shaft 1010 is within a distance deviation threshold of any part of the landmark (e.g., within a horizontal distance of up to 20% of the total screen width and a vertical distance of up to 20% of the total screen width). In some examples, the distance deviation threshold could be based on an averaging or mean over a length of the tool shaft relative to a length of the landmark. In some examples, both a defined angle orientation deviation threshold and a distance deviation threshold may be applied in the case of determining if a touch input tool shaft placement is located or coincides with a displayed landmark that has relevant location and orientation features (e.g., do touch coordinates for a tool shaft placement gesture fall within the orientation deviation threshold from a separator and within the distance threshold of the separator).

The spatial deviation thresholds indicated above are examples. Other threshold values can be used, and in some examples may be user defined. Deviation thresholds may also be applied when classifying movement gestures—for example, in some embodiments a tool shaft drag gesture need not be perfectly linear and could be permitted to include a threshold level of on-screen rotation of the touch input tool shaft 1010 during the movement. Similarly, a tool shaft rotation gesture need not be perfectly rotational and could be permitted to include a threshold level of linear on-screen drag of the touch input tool shaft 1010 during the movement. In some examples, an on-screen movement that exceeded both the on-screen rotation and on-screen liner movement thresholds may be classified as a combined on-screen “tool shaft drag and rotate gesture”.

In example embodiments, the touch pattern classification performed by UI module 116 may be a multiple step process in which the basic gestures described above are combined to provide multi-step gestures. For example, the UI Module 116 may be configured to first classify if the touch coordinate information matches a generic touch pattern for placement of the tool shaft 1010 on the touchscreen display 45. For example, touch coordinate information matching a touch pattern that corresponds to placement of an elongate rigid body at any location or orientation on the touchscreen display 45 may be classified as a tool shaft placement gesture. An orientation (e.g., horizontal or vertical) determined from the touch coordinate information can then be used to further classify the tool shaft placement gesture as vertical or horizontal tool shaft placement gesture, and define the location of the touch input tool placement relative to a landmark. Following the tool shaft placement gesture, subsequent on-screen movements and removal of the tool shaft can be classified as further basic gestures, with the multiple gestures forming a multiple part gesture such as will be described below.

With respect to the tool shaft drag and tool shaft rotate input gestures, as the touch input tool 1000 is moved along a screen of a touchscreen display with the shaft of the touch input tool in contact with the screen, the touch input tool shaft 1010 covers (or sweeps) an area on the touchscreen display. A tool shaft gesture applied to an area of touchscreen display is referred to as an “area interaction”. In example embodiments, area interactions correspond to tool shaft movement gestures (e.g., tool shaft drag gestures, tool shaft rotate gestures, and tool shaft drag-rotate gestures) that occur in conjunction with an area that is rendered on the touchscreen display by UI module 116 or a further application 120. Area interaction is intuitive for a user to learn and use. Specific actions can be performed based on specific area interactions. This can lead to increased productivity and simpler user interfaces on touchscreens. Various examples of the area interactions by a touch input tool 1000, such as a stylus, are described below, by way of example only and not limitation.

In one embodiment of the present disclosure area interaction by a touch input tool is used to enlarge or zoom an area of a map. With reference to FIG. 4A, an electronic device 100 is shown. Included as one of the applications 120 is a mapping application 120A (illustrated by dash-dot line in FIGS. 4A and 4B). In the illustrated example, mapping application 120A (is running on the electronic device 100 and causes a map user interface 200 to be rendered on the main viewing area 55 of the touchscreen display 45. In the example embodiment, UI module 116 and the mapping application 120A are collectively configured to determine when a tool shaft drag gesture occurs that corresponds to an area interaction. In the illustrated example, the touch input tool 1000 is placed at a first position on the screen 48 of the touchscreen display 45 of electronic device 100 in a tool shaft placement gesture. The touch input tool 1000 is shown at the first position in dotted lines. The touch input tool 1000 is then dragged across the screen, in the direction of the arrow 74, while substantially maintaining its orientation. This represents a tool shaft drag gesture as described above. At the end of the tool shaft drag gesture the touch input tool 1000 is at a second position and is shown in solid lines. During the too shaft drag gesture between the first and second positions, the touch input tool 1000 sweeps an area 250 of the map 220. In one embodiment, the area 250 (e.g., the tool shaft interaction area) that is swept by the shaft 1010 of the touch input tool 1000 is a rectangular area defined in a first spatial dimension (e.g., vertically) by the length of the shaft 1010 and in a second spatial dimension (e.g. horizontally) by the distance covered by the drag gesture. In the case of the vertical tool orientation, horizontal drag shown in FIG. 4A, the tool shaft interaction area 250 is rectangular in shape and is bounded two vertical sides that correspond to the length of tool shaft, and two horizontal sides represented by virtual boundary lines 252A and 252B that correspond to the distance of the horizontal drag. The virtual boundary line 252A traces the path of the axial end 1016 of the touch input tool 1000, as the touch input tool 1000 is dragged along the screen 48 and virtual boundary 252B traces the path of the axial end 1018. As the touch sensing system 112 detects the tool shaft 1010 at various intermediate positions along the way between the first position and the second position, the touchscreen driver 114 provides updated touch coordinate information to the UI module 116. In an example embodiment, UI module 116 matches the touch coordinate information to patterns that correspond to a tool shaft placement and drag gesture and provides spatial and temporal data about the a tool shaft placement and drag gesture to mapping application 120A, enabling the mapping application 120A to determine the boundaries of the tool shaft interaction area 250, the orientation of the tool shaft 1010, and the drag direction and timing. When touch tool 1000 is lifted off the screen, in a tool shaft removal gesture, the touch sensing system 112 in conjunction with the touchscreen driver 114 provides the corresponding touch coordinate information to the UI module 116, which detects the tool shaft removal gesture and provides that information to the mapping application 120A. Mapping application 120A determines the tool shaft interaction area 250 based on the touch coordinate information, and in particular the starting location of a tool shaft movement gesture and an ending location of the tool shaft movement gesture on the touchscreen display.

In the illustrated example, mapping application 120A is configured to perform a predetermined action in response to tool shaft placement, drag and removal gestures. In one embodiment, that predefined action is to re-render the map as shown in FIG. 4B, such that the information shown in tool shaft interaction area 250 is enlarged to occupy the entire viewing area 55 of the touchscreen display 45 of electronic device 100. Accordingly, a “zoom-in” function of enlarging the tool shaft interaction area 250 of a map was accomplished with an intuitive “area interaction” by the touch input tool 1000.

In the illustrated example, the area interaction is comprised of a tool shaft placement gesture at a first position followed by a tool shaft drag gesture in a first direction (e.g. to the right) to define a tool shaft interaction area, followed by a tool shaft removal gesture. The area interaction triggers a zoom-in function. In another example, the same combination of gestures with a tool shaft drag in the opposite direction (e.g. to the left) could be used to trigger a “zoom-out” function. For example, placement of the touch tool 1000 at the left boundary of area 250 in FIG. 4A, followed by a left drag gesture to the right boundary of area 250 and subsequent removal of touch tool 1000 can be interpreted by mapping application 120A as a user input request for a “zoom-out” function, causing the mapping application 120A to re-render the map such that the entire viewing area 55 containing the map 200 is to be reduced in size to fit in the interaction area 250. In this case, other portions of the map 200 which are currently not displayed are rendered around the reduced map which occupies the interaction area 250. Accordingly, the area interaction shown may be interpreted by the mapping application to indicate a resizing operation such as a zoom in or a zoom out operation.

In yet another embodiment, the area interaction could be used to re-center the displayed map 200 in the viewing area 55 such that the interaction area 250 is in the center thereof. In a further embodiment, the tool shaft drag gesture is interpreted by the mapping application to include a pan operation. In this example the distance between the touch input tool in the first position and the second position is detected, and the entire map 200 is moved in the direction of the tool shaft drag gesture by the distance that the shaft 1010 covers between the first position and the second position. In some examples, area interactions having similar spatial attributes may result in different actions based on temporal attributes. For example, a tool placement-drag right gesture on the map image followed by a removal gesture within a defined time period after the drag gesture (e.g. 1 s) could be interpreted as a “zoom-in” instruction, whereas a tool placement-drag right gesture that is not followed by a removal gesture within the defined time period could be interpreted as a “pan left” instruction that scrolls the displayed map image to the right.

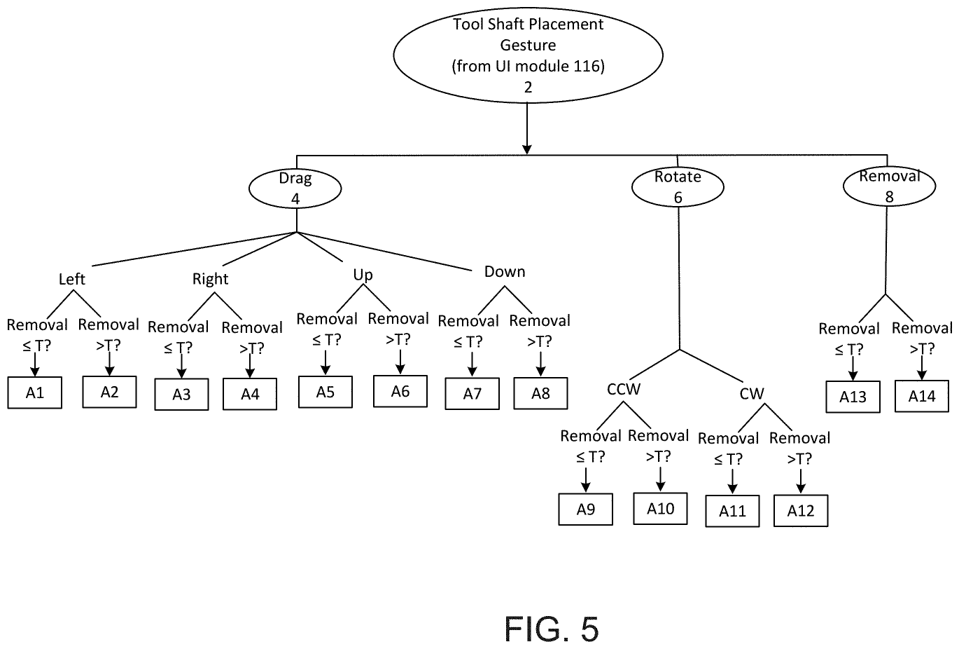

An example of collective processing of different area interactions by UI module 116 and an application 120 such as mapping application 120A is represented by the flow diagram of FIG. 5. As indicated by item 2, a tool shaft placement gesture is detected, followed by either a tool shaft drag gesture (item 4), a tool shaft rotate gesture (item 6), or a tool shaft removal gesture (item 8). In the case of a tool shaft placement and drag gestures, a direction of the drag motion is determined relative to the screen orientation (e.g. left, right, up, down), as well as the timing of any subsequent removal option. As indicated in the FIG. 5, in the case where a tool shaft placement-drag-removal gesture is classified in one of four movement directions and compared to a threshold time for tool removal, then eight different input possibilities can be conveyed by tool shaft placement-drag-removal gesture, each of which can correspond to a respective predetermined action A1 to A8. Furthermore, the distance and location of the drag gestures (which determines the size of the tool shaft interaction area 250) can provide further input that can determine parameters of any of the actions A1 to A8.

By way of example, in the case of mapping application 120A, tool shaft placement-right drag-removal within time T (e.g., 1s) gesture corresponds to action A3, which as noted above is a zoom-in function that enlarges the map scale such that map portion rendered in the tool shaft interaction area 250 is enlarged to fill the entire display area. A tool shaft placement-left drag-removal within time T (e.g., 1 s) gesture corresponds to action A1, which as noted above is a zoom-out function that reduces map scale so that more of the map is rendered on the touchscreen display. In some examples, tool shaft placement-up and down drag-removal within time T gestures may result in similar actions, with action A5 corresponding to a zoom-in function and action A7 corresponding to a zoom-out function. In some examples, tool shaft placement-right drag with no removal within time T gesture corresponds to action A4, which may correspond to a pan left function that scrolls the rendered map image to the right. Tool shaft placement—left, up or down drag with no removal within time t gestures could each correspond to scroll left (action A2), scroll up (Action A6) and scroll down (Action A8), for example.

Similarly, a set of different actions (Actions A9 to A12) could be associated with tool shaft placement-rotate-removal gestures depending on the direction of rotation (CCW— counterclockwise, CW— clockwise) and the time interval between the rotation gestures and the removal gesture.

Furthermore, tool shaft drag and rotate gestures can be combined to define tool shaft interaction areas that have shapes that are not rectangular or circular.

Further action inputs can be added by considering further temporal and spatial attributes of tool shaft input gestures beyond those shown in FIG. 5, however from a practical aspect as the number of input possibilities increases, the intuitiveness of the gesture to user may decrease. In some examples, one or both of UI module 116 and application(s) 120 may be user configurable to allow a user to customize the tool shaft gesture combinations associated with different actions, thereby enabling the number and complexity of available tool shaft input gestures to be adjusted to the preferences of the user.

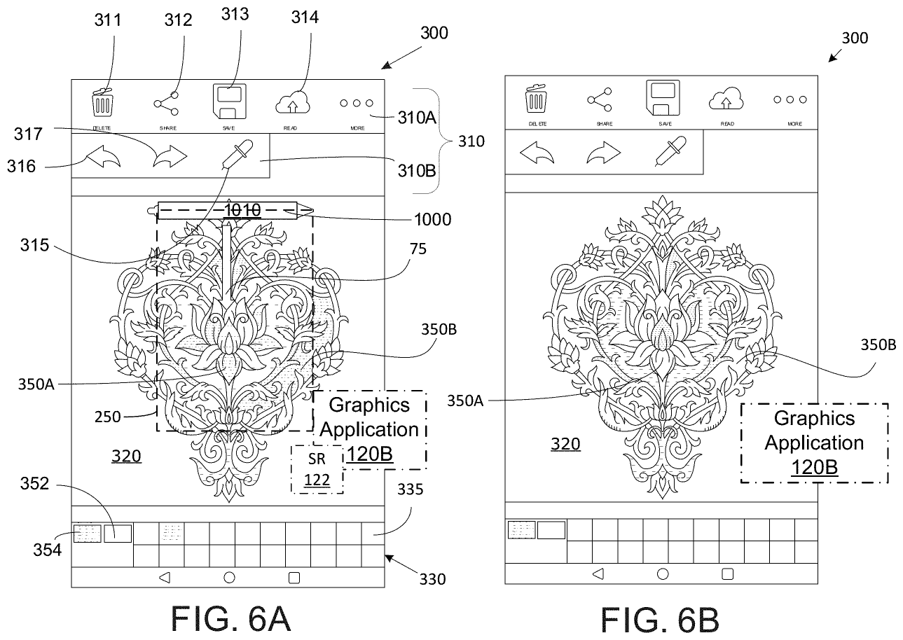

With reference to FIGS. 6A and 6B, an embodiment of the present disclosure in which an area interaction with a further application 120, namely drawing/painting graphics application (“graphics application 120B”) is depicted. A graphics application user interface 300 is shown. The graphics application 120B may be running on an electronic device 100 featuring a touchscreen display 45 as described before. The user interface 300 of the graphics application may occupy part or all of the main viewing area 55 of the touchscreen display 45. The user interface 300 of the graphics application has a toolbar 310, a drawing area 320, and a color palette 330.

The toolbar 310 is comprised of a top toolbar portion 310A and a bottom toolbar portion 310B (collectively “toolbar 310”). The toolbar 310 has a plurality of touch selectable graphical user interface (GUI) control elements that correspond to respective functions that can be performed in respect of an image rendered in drawing area 320. For example, a deletion control element 311 controls a delete function that enables the deletion of the current drawing rendered in drawing area 320 or a selected portion thereof. A share control element 312 controls a share function that enables the currently rendered drawing to be shared with other applications running on the same electronic device. A save control element 313 controls a save function that enables the current drawing to be saved to storage, such as a hard drive or a flash memory. A cloud sharing control element 314 controls an upload function that allows for uploading the drawing to a cloud server. A color pick-up control element 315 controls a color selection function. An undo control element 316 controls an undo function that undoes the last action performed on the drawing in the drawing area 320. A redo control element 317 controls a redo function redoes the last undone action. The color palette region 330 includes a menu or list of color elements 335 that can be selected to activate different fill colors for filling different regions of a drawing rendered in the drawing area 320 therewith. In particular, the rendered drawing is a combination of discrete regions or graphic image elements (e.g. 30A, 350B) that each have a defined set of attributes, including for example fill color attribute, boundary line color and weight and style attributes, and fill pattern attribute.

In an example embodiment, graphics application 120B includes one or more functions that enables a selected attribute of one or more graphic elements rendered within a touch tool interaction area to be modified. One example is a select and replace (SR) function 122 that can be controlled through an area interaction of the display screen by tool shaft 1010 of touch tool 1000. Select and replace function 122 is configured to enable a selected attribute (e.g. a fill color attribute) of image elements within a tool shaft interaction area to be replaced with a different attribute.

In FIGS. 6A and 6B, the drawing rendered in drawing area 320 has different regions, each corresponding to a respective image elements, filled (painted) with different colors. Some of the fill regions are filled with the same color (e.g., color “A”). For example image elements 350A and 350B are both filled with the same color (existing color A) in FIG. 6A. In the illustrated example a user desires to change the fill color of the image elements of the drawing rendered with the fill color “A”, including image elements 350A and 350B, to a different fill color, for example fill color “B”. In one example, a set of tool shaft tip or finger input gestures can be used in combination with a tool shaft area interaction to effect to the color substitution.

By way of example, in one embodiment, graphics application 120B may be configured to implement color select and replace function 122 upon detecting the following touch input event sequence based on touch event information generated by UI module 116:

“Color Select and Replace” function sequence: (1) A touch input (e.g., tool tip or finger touch) at a screen location that corresponds to a “replace selected color” element 354, which signals to graphics application 120B that a user is requesting the color select and replace function 122. (2) A touch input (e.g., tool tip or finger touch) at a screen location corresponding to one of the color elements 335 of color palette 330 signals to graphics application 120B the selected color that the user desires to replace (e.g., color “A”). In some examples, once chosen, the selected color may be indicated in the GUI, for example the “replace selected color” element 354 may be re-rendered using the selected color. (3) A touch input (e.g., tool tip or finger touch) at a screen location corresponding to a further one of the color elements 335 of color palette 330 signals to graphics application 120B the color that the user desires to use as the replacement color (e.g., color “B”). In some examples, the selected replacement color may be indicated in the GUI, for example a “replacement color” element 352 may be re-rendered using the selected replacement color. In some examples, “replacement color” element 352 may be rendered with a default fill color (e.g. “white” or “no fill”) that will be used as a selected replacement color in the event that a user does not actively select a color element 335 for the replacement color. (4) A tool shaft area interaction, comprising a tool shaft placement and drag gesture, defines a tool shaft interaction area 250. In response to the tool shaft area interaction, the graphics application 120B causes all of the image elements 350A, 350B displayed fully or partially within the tool shaft interaction area 250 that are filled with the existing fill color (e.g., color A) to be re-rendered using the replacement fill color (e.g., color B). In some examples, the on-screen movement of tool shaft 1010 include a rotation gesture as it is dragged so that the tool shaft interaction area 250 need not be a rectangle. In some examples, on-screen movement of tool shaft 1010 may be all rotation and no drag.

In some example embodiments, all image elements of the existing fill color (e.g., color A) for the entire drawing area 320 may be re-rendered with the replacement color, not just the regions located fully or partially within the tool shaft interaction area 250.

In example embodiments, detection of a touch input at the location of save control element 313 will cause a representation of the rendered drawing or image, with updated color attributes, to be saved to non-transient storage, and/or detection of a touch input at the location of cloud sharing control element 314 will cause a representation of the rendered drawing or image, with updated color attributes, to be uploaded to a cloud server.

Color replacement (also referred to as color filtering) is one example of content modification that can be performed in response to a tool shaft gestures. Other operations such as closing the current drawing, panning across the current drawing, saving and closing the current drawing, and sharing the current drawing may also be implemented using tool shaft gestures in some examples. For example, a tool shaft drag gestures in a downwardly direction (in the direction of arrow 75) may indicate that the current drawing is to be saved. A tool shaft drag gesture from a first position near the bottom of the drawing to a second position near the top of the drawing may indicate that the drawing is to be uploaded to cloud storage. In other examples, the touch input tool 1000 is placed in a generally vertical orientation near one of the right and left side borders of the drawing area 320. Then the touch input tool 1000 is dragged to the left or to the right to perform a tool shaft drag gesture across the drawing area 320. The graphics application 120B may respond to the right or left tool shaft drag gestures by panning or re-centering the current drawing displayed in the drawing area 320. In other embodiments, different operations may be carried out by the graphics application 120B on the interaction area swept by the tool shaft drag gesture. For example, the interaction area may be cut, pasted, flipped, enlarged, shrunk or manipulated using any other known image processing technique.

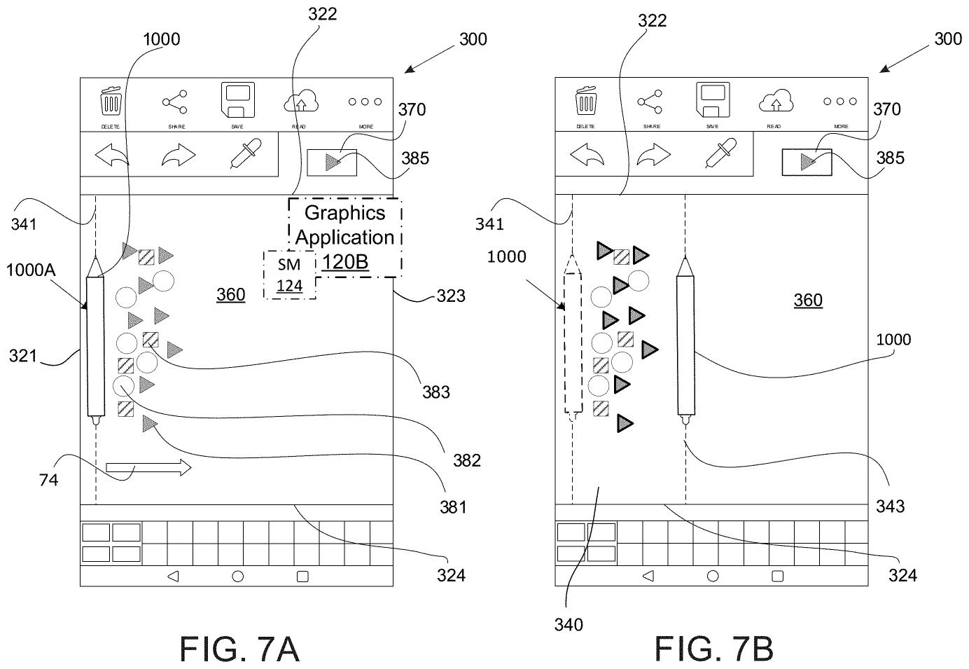

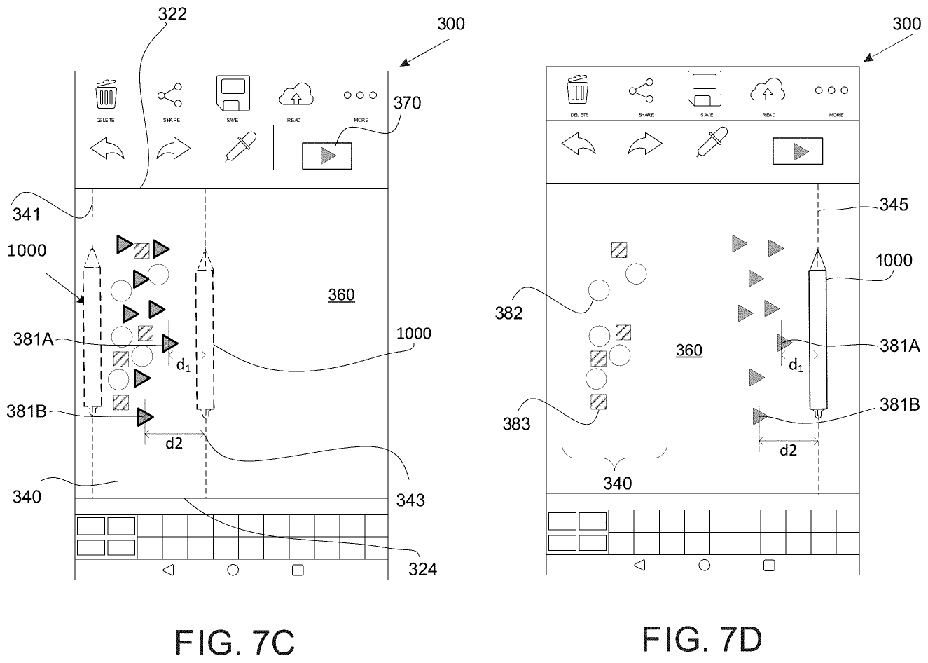

Area interaction utilizing touch input tool shaft placement, drag, rotate and removal gestures may have other applications in which a plurality of objects are manipulated. With reference to FIGS. 7A-7D, the user interface 300 of graphics application 120B is illustrated according to a further example embodiment. In the present example, graphics application 120B is configured to implement a select-move (SM) function 124 that enables a move, or cut and paste, action to be performed exclusively in respect a selected class or type of image elements. The graphics application user interface 300 and its controls have been described above with reference to FIGS. 6A and 6B. In FIGS. 7A-7D, the graphics application 120B has a rectangular drawing area 360 bounded by a left edge 321, a top edge 322, a right edge 323 and a bottom edge 324. In the shown example, the drawing area 360 contains a heterogeneous group of three different types or classes of image elements, namely a first plurality of triangular objects 381, a second plurality of circular objects 382 and a third plurality of square object 383. The plurality of image elements 381, 382, and 383 are intermixed on the drawing area 320.

SM function 124 enables a plurality of image elements of a same type to be selected and moved (e.g., cut from one location and pasted to another location) by utilizing a combination of tool tip (or finger) touch gestures and tool shaft gestures. By way of example, in one embodiment, graphics application 120B may be configured to implement SM function 124 upon detecting the following touch input event sequence based on touch event information generated by UI module 116:

“Select and Move” function sequence: (1) A touch input (e.g., tool tip or finger touch) at a screen location that corresponds to one of the displayed image object, for example a triangle object 381, signals to graphics application 120B that a user has selected an object type (e.g. triangle). (2) A touch input (e.g., tool tip or finger touch) at a screen location corresponding to a move control element 370 signals to graphics application 120B that a user desires to perform a move action in respect of the selected image object type (e.g. triangle). In some examples a visual indicator 385 of the selected image object type may be rendered at or near the move control element 370 to provide user feedback of the selected object type. (3) A tool shaft area interaction, comprising a tool shaft vertical placement gesture along dashed line 341 (FIG. 7A) and a tool shaft horizontal drag gesture in the direction of arrow 74 to dashed line 343 (FIG. 7B) is detected by graphics application 120B, defining a corresponding tool shaft interaction area 340. In this example, the tool shaft interaction area 340 is in the form of a rectangle bounded by the drawing area top edge 322, the bottom edge 324, the first dashed line 341 and the second dashed line 343. In example embodiments, graphics application 120B selects all of the image elements of the selected type (i.e. triangle) within the tool shaft interaction area 340. In some examples, a visual marker is rendered in the user interface 300 to identify the selected image elements (e.g., in FIG. 7B the triangular objects 381 are shown with highlighted borders to indicate that they have been selected). Accordingly, the tool shaft drag gesture of the touch input tool 1000 has caused objects matching a particular criteria (e.g. shape or type) within an interaction area 340 to be selected. (4) A tool shaft removal gesture (FIG. 7C) signals to the graphics application 120B that an object selection step is completed. As the touch input tool 1000 is removed, its last known location (e.g. dashed line 343) is recorded by the graphics application 120B. Additionally, graphics application 120B determines and records the relative locations of the selected objects with respect to each other and with respect to line 343. For example, the graphics application records the distance d1 between selected object 381A and the vertical line 342. Similarly, the graphics application 120B records the distance d2 between the selected object 381B and the vertical line 342. (5) A subsequent tool shaft placement gesture at a different location (e.g., along dashed vertical line 345 as shown in FIG. 7D) of the drawing area 360 signals to the graphics applications 120B where the selected objects are to be moved to. Accordingly, the graphics application 120 re-renders the drawing area 360 with selected triangular objects 381 at the same relative locations to each other that they were originally in, and at distances from the line 345 which are similar to their respective distances from line 343. For example, the triangular object 381A is placed at a distance d1 from the line 345, and the triangular object 381B is placed at a distance d2 from the line 345. As indicated in FIG. 7D, in the re-rendered drawing the selected object types (e.g. triangular objects) are removed from the tool shaft interaction area 340 and the unselected object types (e.g., circular and square objects) that were originally located in the tool shaft interaction area 340 are unaffected by the area interaction and remain in their original locations.

In example embodiments, detection of a touch input at the location of save control element 313 will cause a representation of the rendered drawing or image, with updated object locations, to be saved to non-transient storage, and/or detection of a touch input at the location of cloud sharing control element 314 will cause a representation of the rendered drawing or image, with updated object locations, to be uploaded to a cloud server.

Although a select and move function 124 has been described in respect of FIGS. 7A to 7D, in example embodiments graphics application 120B is configured to also implement a select-copy-paste function. Such a function would be similar to that described above, except that it could be activated by touch selection of a copy and paste control element, and the graphics application 120B would not remove the selected object types (e.g. triangular objects) from the tool shaft interaction area 340 when re-rendering the drawing. For example, the final drawing rendered in FIG. 7D, would include two identical sets of the triangular objects 381—the original set intermixed with the other image type objects 382, 383 as shown in the right half of the drawing area 360 in FIG. 7A, and the copied set as shown in the left half of the drawing area 360 in FIG. 7B.

In some embodiments, other operations may be performed on the selected objects other than being moved or copied. In such embodiments, the tool shaft drag gesture across the plurality of objects selects the objects but does not move them. Other controls may be invoked in the graphics application. For example, it may be desired to enlarge the triangular objects 381 without moving them away from circular objects 382 and square objects 383. In this case, the tool shaft drag gesture selects the objects 381, and an Enlarge control (not) shown is actuated. In another example, it may be desired to change the color of the selected objects 381. In this case, the tool shaft drag gesture selects the triangular objects 381 and tapping a color 335 from the color palette 330 changes all selected objects to the tapped color 335.

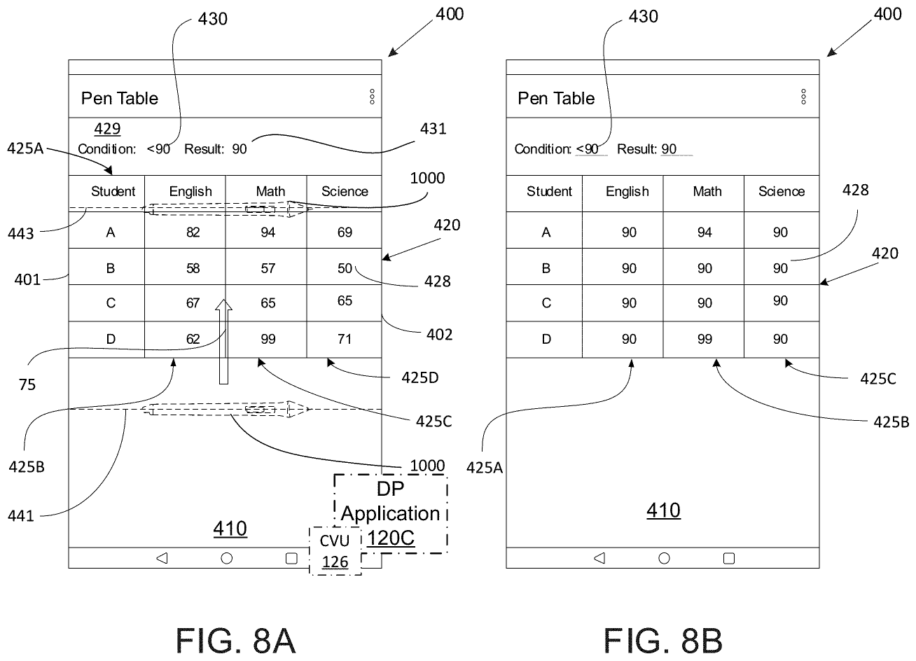

The use of area interactions is not limited to applications which are graphical in nature such as mapping and graphics applications. Applications which process numerical data can also utilize area interaction which includes tool shaft drag gestures. Referring to FIGS. 8A and 8B, in example embodiments, a data processing (DP) application 120C (such as a spread sheet application) is configured to cause a data processing operation to be performed based on an area interaction. For example, a range of cells in a spreadsheet application may need to be selected and have one or more processing operations applied thereto. The processing may be one or more of: text formatting, numerical formatting, mathematical function, and the like. In one embodiment, discussed with reference to FIGS. 8A-8B, data processing application 120C renders a spreadsheet application user interface 400 that displays a spreadsheet page 410. The spreadsheet page 410 has a table 420 comprised of a number of table columns 426A, 426B, 425C and 425D (collectively “425”). Table columns 426B-425D are each comprised of a plurality of cells 428 containing numeric data.

In the illustrated example, data processing application 120C is configured to implement a cell value update (CVU) function 126. CVU function 126 operates to update any value in a cell that is located in a tool shaft interaction area in accordance with a predefined numerical update function. In example embodiments, the numerical update function can be selected from a set of predefined functions or defined by a user, and is displayed in a region 429 of the spreadsheet application user interface 400. In the illustrated example, the numerical update function is a conditional function with user defined conditional statement and result. For example, in the example shown, the numeric data are grades and it is desired that any value in a cell 428 which does not meet a predefined condition be replaced with a value that does meet the condition. This is illustrated by the condition field 430 and result field 431 shown in the figures. The condition 430 checks if the value “<90” is satisfied by a particular cell, such as cell 428. The result field 431 specifies what the value of a selected cell should be if the condition 430 is met. In the illustrated example, the value of the cell 428 should become 90 if the condition 430 is met.

In the illustrated example, tool shaft area interaction is used to select the cells that the predefined numerical update function is applied to as follows. The touch input tool is placed on the screen 48 below the table columns 425, in a tool shaft placement gesture and is shown in dotted lines as touch input tool 1000A. The location of touch input tool 1000 is approximated by a horizontal line 441. The touch input tool is then moved in the direction of the arrow 74, in a tool shaft drag gesture, to a new location approximated by a horizontal line 443. During the tool shaft gesture, the touch input tool 1000 sweeps an interaction area of the spreadsheet 410 that includes the table columns 425. The interaction area is rectangular in shape and is bounded by the virtual horizontal line 441, the right edge 402, the virtual horizontal line 443 and the left edge 401. The cells of the table columns 425 are selected as the touch input tool is dragged across the table 420. Finally, the touch input tool 1000 is lifted off the screen in a tool shaft removal gesture. Upon detecting the completion of the area interaction followed by the tool shaft removal gesture, the data processing action 102C causes the predefined numerical update function (shown in region 429) to be applied to the cells within the interaction area. With reference to FIG. 8B, it can be seen that all cells 428, which met the condition 431 (e.g., <90) now contain a value of 90 in accordance with the result field 431. Accordingly, with a simple area interaction, a plurality of values can be changed by applying a defined function, such as a conditional functions, thereto. In some embodiments, the tool shaft drag gesture causes the function to be applied to an entire spreadsheet.

While the embodiment shown in FIGS. 8A-8B, showed testing a numerical condition and changing a numerical value, there are other possible conditions and actions which may be performed on a numerical data application. For example, the condition tested may apply to other types of data such as textual data, date and time, currency, and the like. Complex Boolean conditions may be specified in the condition field 430. In some embodiments, the result field may specify formatting instead of changing the numerical value. For example, with reference to FIGS. 8A-8B, the result field 431 may specify that values less than 90 be displayed in red, in bold numbers, or underlined. The data processing application is not limited to spreadsheet applications, and may include database systems, accounting software, and the like.

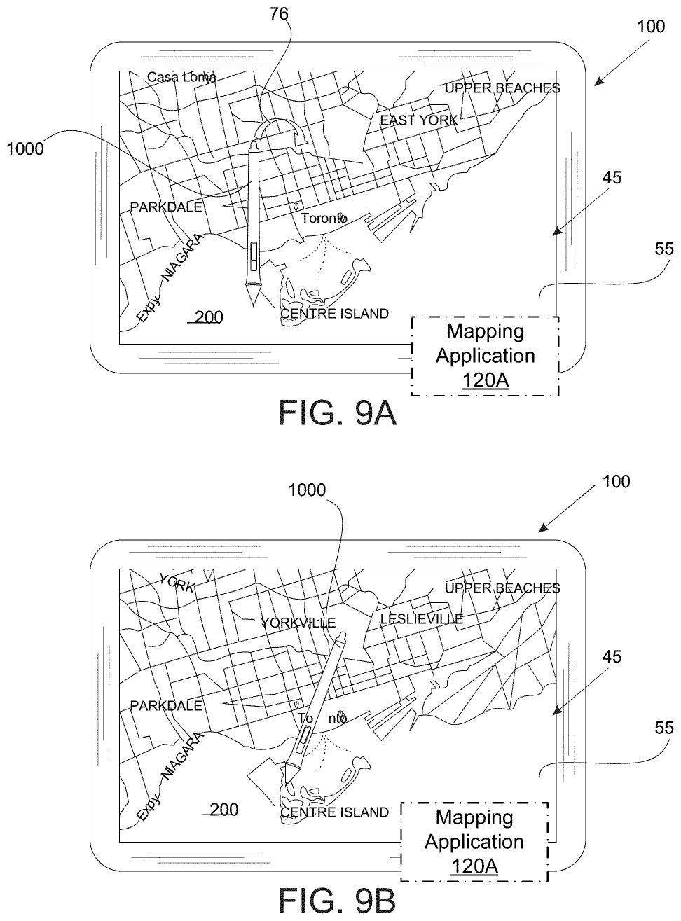

A further example of an area interaction in respect of mapping application 120A is illustrated in FIGS. 9A and 9B. An area interaction including a tool shaft rotate gesture is used to rotate the view of a mapping application. An electronic device 100 is shown running a mapping application displaying a map 200 in the main viewing area 55 of the touchscreen display thereof. A touch input tool 1000, in the form of a stylus, is placed on the screen of the touchscreen display of the electronic device 100 in a first orientation shown in FIG. 9A. The touch input tool 1000 is then rotated, in a tool shaft rotate gesture in the direction of arrow 76, to be in a second orientation as shown in FIG. 9B. Touch coordinate information corresponding to the movement of the touch input tool shaft 1010 is generated by the touch sensing system 112 and the touchscreen driver 114 as discussed above. The UI module 116 passed on information regarding the tool shaft rotation gesture to the mapping application 120A, including an angle of rotation which is the angle between the stylus 1000 in the first orientation in FIG. 9A and the stylus 1000 in the second orientation after being rotated as shown in FIG. 9B. The mapping application 120A causes the map 200 to be re-rendered, rotated by the angle of rotation.

While the tool shaft rotate gesture was utilized in a mapping application, it is applicable to other types of graphical applications. For example, a tool shaft rotate gesture may be used in a Computer Aided Design (CAD) program to rotate two-dimensional or three-dimensional objects.

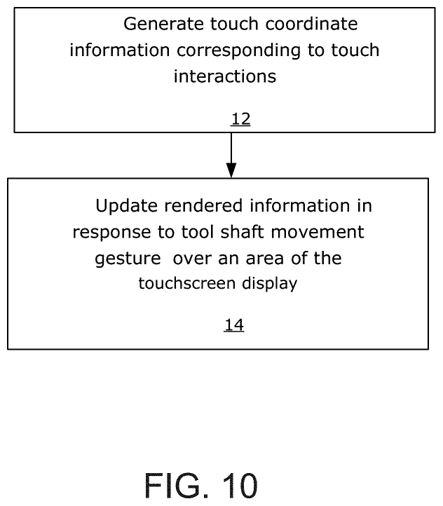

With reference to FIG. 10, the embodiments described above can be summarized as follows. In example embodiments, the touch sensing system 112 and touchscreen driver 114 of an electronic device 100 are configured to generate touch coordinate information corresponding to touch interactions with touchscreen display 45 (block 12). A software application 120, in conjunction with a UI module 116, is configured to update information rendered on the touchscreen display 45 in response to determining that the touch coordinate information matches a tool shaft movement gesture corresponding to movement of a touch tool shaft 1010 over an area of the touchscreen display 45.

In example embodiments, a touch tool interaction area is defined based on the touch coordinate information, and updating of the information rendered on the touchscreen display is selectively performed on information included within the touch tool interaction area. In some examples, defining the touch tool interaction area comprises determining, based on the touch coordinate information, a starting location of the touch tool shaft movement gesture and an ending location of the touch tool shaft movement gesture on the touchscreen display 45. The tool shaft movement gesture corresponds to one or more of: a tool shaft drag gesture, a tool shaft rotation gesture, and a combined tool shaft drag and rotation gesture. The starting location of the tool shaft movement gesture corresponds to a location of a tool shaft placement gesture on the touchscreen display and the ending location of the tool shaft movement gesture corresponds to a tool shaft removal gesture from the touchscreen display 45.

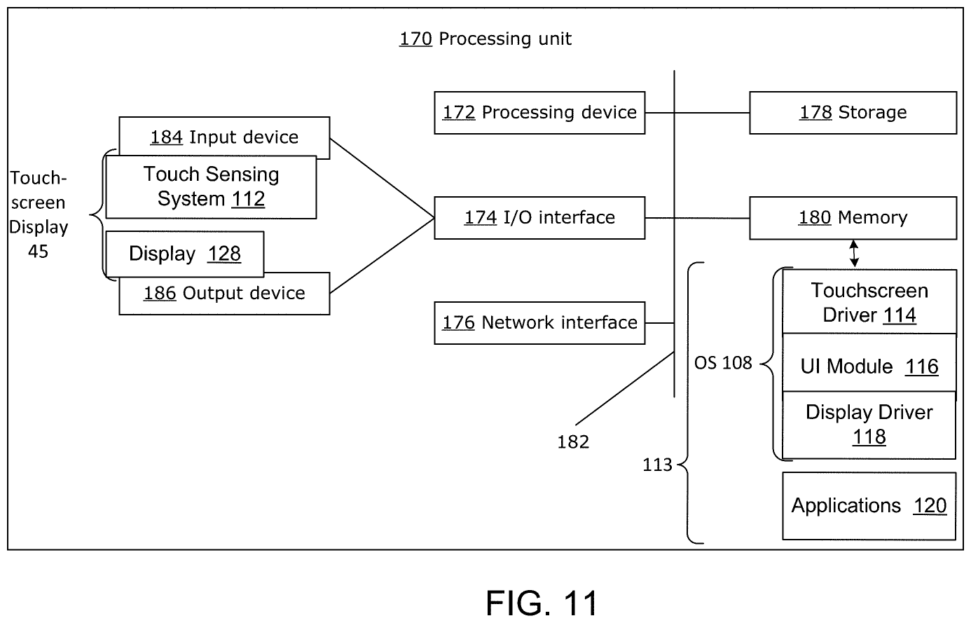

FIG. 11 is a block diagram of an example processing unit 170, which includes the components of touchscreen display system 110 and may be used to implement the electronic device 100. The processing unit 170 may be used to execute machine readable instructions, in order to implement methods and examples described herein. Other processing units suitable for implementing embodiments described in the present disclosure may be used, which may include components different from those discussed below. Although FIG. 11 shows a single instance of each component, there may be multiple instances of each component in the processing unit 170.

The processing unit 170 may include one or more processing devices 172, such as a processor, a microprocessor, an application-specific integrated circuit (ASIC), a field-programmable gate array (FPGA), a dedicated logic circuitry, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network (e.g., an intranet, the Internet, a P2P network, a WAN and/or a LAN) or other node. The network interfaces 176 may include wired links (e.g., Ethernet cable) and/or wireless links (e.g., one or more antennas) for intra-network and/or inter-network communications.

The processing unit 170 may also include one or more storage units 178, which may include a mass storage unit such as a solid state drive, a hard disk drive, a magnetic disk drive and/or an optical disk drive. The processing unit 170 may include one or more memories 180, which may include a volatile (e.g. random access memory (RAM)) and non-volatile or non-transitory memories (e.g., a flash memory, magnetic storage, and/or a read-only memory (ROM)). The non-transitory memory(ies) of memories 180 store programs 113 that include software instructions for execution by the processing device(s) 172, such as to carry out examples described in the present disclosure. In example embodiments the programs 113 include software instructions for implementing operating system (OS) 108 (which as noted above can include touchscreen driver 114, UI module 116 and display driver 118, among other OS components) and other applications 120 (e.g., mapping application 120A, graphics application 120B and data processing application 120C). In some examples, memory 180 may include software instructions of the system 100 for execution by the processing device 172 to carry out the display content modifications described in this disclosure. In some other examples, one or more data sets and/or modules may be provided by an external memory (e.g., an external drive in wired or wireless communication with the processing unit 170) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 182 providing communication among components of the processing unit 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

In FIG. 11, the input device(s) 184 include touch sensing system 112 of the touchscreen display 45, and may also include other input devices (e.g., a keyboard, a mouse, a microphone, accelerometer, and/or a keypad) Output device(s) 186 includes the display 128 of touch-screen display 24 and may also include other devices such as a speaker and a tactile generator.

Although the methods presented in the present disclosure discuss using area interaction with certain applications, area interaction may be used at the graphical operating system level as well. For example, area interaction may be applied to a home screen of a graphical operating system to perform one of the following actions: reorganize icons, resize icons, invoke a screensaver, or any other suitable action applicable to a home screen.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
generating touch coordinate information corresponding to touch interactions with a touchscreen display of an electronic device;
updating information rendered on the touchscreen display in response to determining that the touch coordinate information matches a tool shaft movement gesture corresponding to movement of a touch tool shaft over an area of the touchscreen display.

2. The method of claim 1, comprising:
defining a touch tool interaction area based on the touch coordinate information, wherein updating information rendered on the touchscreen display is selectively performed on information included within the touch tool interaction area.

3. The method of claim 2 wherein defining the touch tool interaction area comprises determining, based on the touch coordinate information, a starting location of the touch tool shaft movement gesture and an ending location of the touch tool shaft movement gesture on the touchscreen display.

4. The method of claim 2 wherein the tool shaft movement gesture corresponds to one or more of: a tool shaft drag gesture, a tool shaft rotation gesture, and a combined tool shaft drag and rotation gesture.

5. The method of claim 4 wherein the starting location of the tool shaft movement gesture corresponds to a location of a tool shaft placement gesture on the touchscreen display and the ending location of the tool shaft movement gesture corresponds to a tool shaft removal gesture from the touchscreen display.

6. The method of claim 2 wherein the updating information rendered on the touchscreen display comprises resizing the information rendered on the touchscreen display.

7. The method of claim 2 wherein updating information rendered on the touchscreen display comprises scrolling information rendered on the touchscreen display based on a direction of the tool shaft movement gesture.

8. The method of claim 2 wherein updating information rendered on the touchscreen display comprises changing a selected attribute of image elements rendered within the touch tool interaction area.

9. The method of claim 8 wherein the selected attribute is a fill color.

10. The method of claim 2 wherein a plurality of image elements of different types are rendered in the touch tool interaction area, and updating information rendered on the touchscreen display comprises selectively moving or copying a plurality of the image elements of a selected type from the touch tool interaction area to a different area of the touchscreen display.

11. The method of claim 2, wherein a plurality of numerical data elements are rendered in the touch tool interaction area, and updating information rendered on the touchscreen display comprises updating values of the data elements included within the touch tool interaction area based on a predetermined function.

12. The method of claim 1 comprising storing the updated information in a non-transitory storage.

13. An electronic device comprising:
a touchscreen display comprising a display and a touch sensing system configured to generate signals corresponding to screen touches of the display;
a processing device operatively coupled to the touchscreen display;
a non-transitory memory coupled to the processing device and storing software instructions that when executed by the processing device configure the processing device to:
generate touch coordinate information corresponding to touch interactions with a touchscreen display of an electronic device; and
update information rendered on the touchscreen display in response to determining that the touch coordinate information matches a tool shaft movement gesture corresponding to movement of a touch tool shaft over an area of the touchscreen display.

14. The electronic device of claim 13, wherein the instructions further configure the processing device to define a touch tool interaction area based on the touch coordinate information, wherein updating information rendered on the touchscreen display is selectively performed on information included within the touch tool interaction area.

15. The electronic device of claim 14, wherein the instructions which configure the processing device to define the touch tool interaction area comprise instructions which configure the processing device to determine, based on the touch coordinate information, a starting location of the touch tool shaft movement gesture and an ending location of the touch tool shaft movement gesture on the touchscreen display.

16. The electronic device of claim 14, wherein the tool shaft movement gesture corresponds to one or more of: a tool shaft drag gesture, a tool shaft rotation gesture, and a combined tool shaft drag and rotation gesture.

17. The electronic device of claim 16, wherein the starting location of the tool shaft movement gesture corresponds to a location of a tool shaft placement gesture on the touchscreen display and the ending location of the tool shaft movement gesture corresponds to a tool shaft removal gesture from the touchscreen display.

18. The electronic device of claim 14, wherein the instructions which configure the processing device to update information rendered on the touchscreen display comprise instructions which configure the processing device to one of: resize the information rendered on the touchscreen display, scroll information rendered on the touchscreen display based on a direction of the tool shaft movement gesture, and change a selected attribute of image elements rendered within the touch tool interaction area.

19. The electronic device of claim 14, wherein a plurality of image elements of different types are rendered in the touch tool interaction area, and updating information rendered on the touchscreen display comprises selectively moving or copying a plurality of the image elements of a selected type from the touch tool interaction area to a different area of the touchscreen display

20. The electronic device of claim 14, wherein a plurality of numerical data elements are rendered in the touch tool interaction area, and updating information rendered on the touchscreen display comprises updating values of the data elements included within the touch tool interaction area based on a predetermined function.
